(19) United States
(12) Patent Application Publication
(10) Pub. No.: US 2006/0233490 A1
(43) Pub. Date: Oct. 19, 2006

(54) Optical print head, method for enhancing light quantity thereof and optical printer

(76) Inventor: Yung-Shan Lin, Neipu Township (TW)

Correspondence Address: RABIN & Berdo, PC, 1101 14TH STREET, NW, SUITE 500, WASHINGTON, DC, 20005, US

(21) Appl. No.: 11/261,770

(22) Filed: Oct. 31, 2005

(30) Foreign Application Priority Data
Apr. 15, 2005 (TW) 94112086

(51) Int. Cl. G02B 6/32

(52) U.S. Cl. 385/33

(57) ABSTRACT

An optical print head and a method for enhancing light quantity thereof and optical printer are provided. A convergent micro-lens set is disposed between the LED lighting plate and the self-focusing micro-lens array, and is used to converge the emitting light generated by the LED lighting plate into the self-focusing micro-lens array. As such, the optical coupling efficiency of the optical print head is increased by increasing the light quantity of entering into the self-focusing micro-lens array.

### CROSS-REFERENCE TO RELATED APPLICATIONS

This non-provisional application claims priority under 35 U.S.C. § 119(a) on patent Application Ser. No(s). 094112086 filed in Taiwan on Apr. 15, 2005, the entire contents of which are hereby incorporated by reference.

### FIELD OF THE INVENTION

The invention relates to an optical print head and a method for using the same, and in particular to an optical print head with high optical coupling efficiency.

### RELATED ART

In the prior art, usually when the light-emitting diode (LED) lighting plate is utilized as the light source of an optical print head. Since its optical coupling efficiency is not high enough, its driving current must be increased so that the LED lighting plate is capable of generating light with higher energy. Also, when the LED lighting plate is utilized as the light source, it requires approximately 5 to 20A operation driving current depending on the actual design of the driver circuit. Thus, after a sustained period of time for operation, an overheating problem may occur.

As shown in FIG. 1A, which is a schematic diagram of the light movement of a conventional print head. When a light-emitting diode 10a is used to generate emitting light 17, part of the emitting light 17 tends to scatter outside the area of a self-focusing micro-lens 20a, along with the increase of the distance traveled by the light. Thus only a portion of the emitting light 17 may enter into the self-focusing micro-lens 20a resulting in the decrease of the optical coupling efficiency for optical print head. In some design configurations, the optical coupling efficiency may be even as low as 0.4217%, which means that, if the light energy generated by the light-emitting diode 10a is 1 mw, then the light energy passing through the self-focusing micro-lens 20a and received at the receiving end of the self-focusing micro-lens 20a is only 0.004217 mw. It is perceived that the optical coupling efficiency for the ordinary optical print head is unsatisfactory.

In order to raise the optical coupling efficiency for the optical print head, a structure of double row self-focusing micro-lens array 21 shown in FIG. 1B is used. In some optical print head designs, the double row self-focusing micro-lens array 21 is utilized; namely, the two parallel rows of the upper and lower self-focusing micro-lenses 21a are used to increase the optical coupling area, so that the emitting light may full enter into the self-focusing micro-lenses 21a. Thus the optical coupling efficiency is increased. However, the production cost of the self-focusing micro-lens array 21 is high. Another way of raising the optical coupling efficiency is to increase the driving current of the light-emitting diode 10a so that the light generated by the light-emitting diode 10a has much more high power energy. However, it will cause that the temperature of the light-emitting diode 10a increases significantly (It causes the above-mentioned problem of overheating) resulted in decreasing of life span for the light-emitting diode 10a.

Therefore, the research and development of an optical print head with higher optical coupling efficiency and requiring less driving current of the light-emitting diode is probably the most urgent task in the development of optical printer technology.

### SUMMARY OF THE INVENTION

In view of the above-mentioned problems of the prior art, the object of the invention is to provide an optical print head, a method for enhancing light quantity thereof and optical printer. The method is used to enable the light emitted from the LED lighting plate to be exposed onto a self-focusing micro-lens array through the convergent micro-lens set disposed between the LED lighting plate and the self-focusing micro-lens array in the optical print head, so as to raise the optical coupling efficiency for the optical print head, and reduce the driving current of the light-emitting diode and the operation temperature of the LED lighting plate.

In order to achieve the above-mentioned object, the optical print head of the present invention includes the elements as below:

An LED lighting plate includes a plurality of light-emitting diodes arranged in matrix. The plurality of light-emitting diodes is driven by receiving the driving current to generate the emitting light. The emitting light may be classified into the main beam and the scattered beam according to its traveling route.

A convergent micro-lens set is disposed in the optical path of the emitting light between the LED lighting plate and the self-focusing micro-lens array so that the emitting light from the LED lighting plate may be converged after it passing through the convergent micro-lens set. The convergent micro-lens set may be classified into a matrix type and column type, and it is made of light transmitting material such as glass, acrylic or the like.

A self-focusing micro-lens array has a plurality of self-focusing micro-lenses corresponding to the arrangement of light-emitting diodes, and is used to receive the emitting light transmitted through the convergent micro-lens set and focus the light on the predetermined imaging point. In addition, the self-focusing micro-lens array may be classified into a single row type and double row type, and is made of light transmitting material such as glass, acrylic or the like.

In addition, in order to achieve the above-mentioned object, the method of utilizing the optical print head provided by the invention includes the following steps:

Firstly, the emitting light is generated by providing the driving current to the light-emitting diodes of LED lighting plate. Next, the emitting light is converged through the convergent micro-lens set to increase the light quantity of entering into the self-focusing micro-lens array. Then, the emitting light is uniformly imaged onto the predetermined imaging point after it passes through the self-focusing micro-lens array.

Through the utilization of the optical print head, and the method for enhancing light quantity thereof and optical printer of the present invention, the emitting light generated by the LED lighting plate may be converged, concentrated and exposed onto the self-focusing micro-lens array, so as to increase the light quantity of entering into the self-focusing micro-lens array, raise the optical coupling efficiency for the optical print head, decrease the driving current used for driving the light-emitting diodes, and reduce the operation temperature of the optical print head to preserve the life span of the light-emitting diodes.

Further scope of the applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given below, which is for illustration only and thus is not limitative of the invention, wherein:

FIG. 1A is a schematic diagram of the light movement of a conventional print head;

FIG. 1B is a schematic diagram of the light movement of another conventional print head;

FIG. 2 is a system block diagram of an optical printer according to the invention;

FIG. 3A is a schematic diagram of the perspective view of the optical print head according to a first embodiment of the invention;

FIG. 3B is a schematic diagram of the perspective view of the optical print head according to a second embodiment of the invention;

FIG. 4A is a schematic diagram of the light movement of the optical print head according to the first embodiment of the invention;

FIG. 4B is a schematic diagram of the light movement of the optical print head according to the second embodiment of the invention; and

FIG. 5 is a flowchart of the steps of the method of utilizing the optical print head according to the invention.

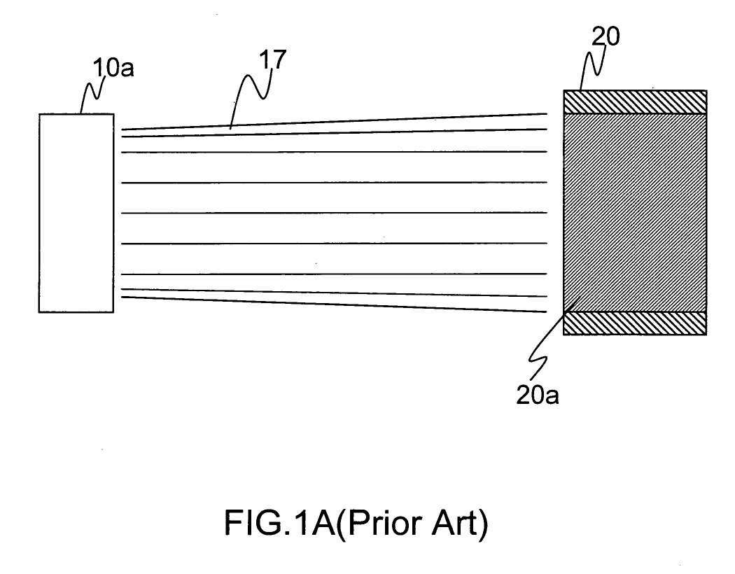

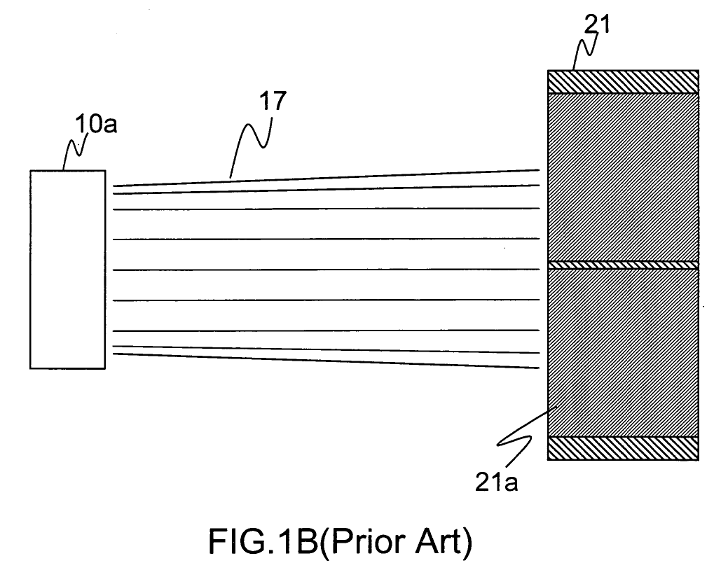

### DETAILED DESCRIPTION OF THE INVENTION

The purpose, construction, features, and functions of the invention can be appreciated and understood more thoroughly through the following detailed description with reference to the attached drawings.

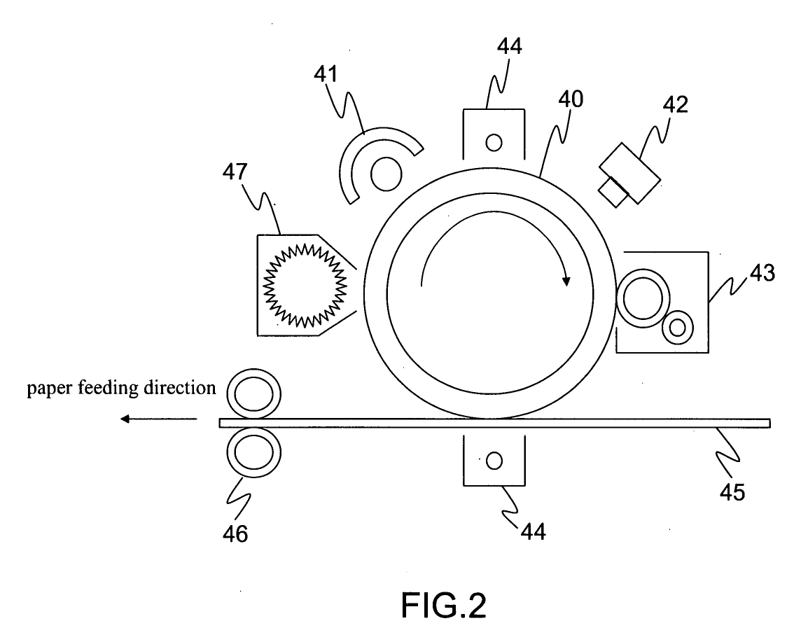

Referring to FIG. 2, a system block diagram of the optical printer according to the invention includes a photosensitive drum 40, a primary charge unit 41, an optical print head unit 42, a developer 43, a transfer 44, a paper 45, a heater unit 46, and a cleaning unit 47. All of these devices will be described in detail as follows.

The photosensitive drum 40 is the core module of the optical printer and has a changing conductivity characteristic by light because of photo-sensing. For example, the photosensitive drum unit 40 is provided with electric conductivity after exposure process, but the unexposed portion has become as insulator.

The primary charge unit 41 is used to place or remove electrostatic charges on the surface layer of the photosensitive drum 40, so as to place a layer of electrostatic charges on the surface layer of the photosensitive drum 40 or remove the electrostatic charges from the surface layer of the photosensitive drum 40.

The optical print head unit 42 is used to receive the driving current to generate the emitting light. The emitting light is used to expose the photosensitive drum 40 to cause a change of the electric potential of the photosensitive drum 40, so as to form the predetermined image formations (e.g. legends or patterns).

The developer 43 is used to apply carbon powder to the surface layer of the photosensitive drum 40. The carbon powder is attached to the surface of the photosensitive drum 40 due to the electric field thereon, so that the corresponding image pattern is formed.

The transfer 44 is used to press the carbon powder attached to the surface of the photosensitive drum 40 on the paper 45, wherein the paper 45 is electrified before passing through the transfer 44 to absorb the carbon powder.

The heater unit 46 is used to heat the carbon powder attached on the paper 45, so as to complete the image printing process.

The cleaning unit 47 is used to remove the carbon powder remaining on the surface of the photosensitive drum 40, so that the next printing process can be executed.

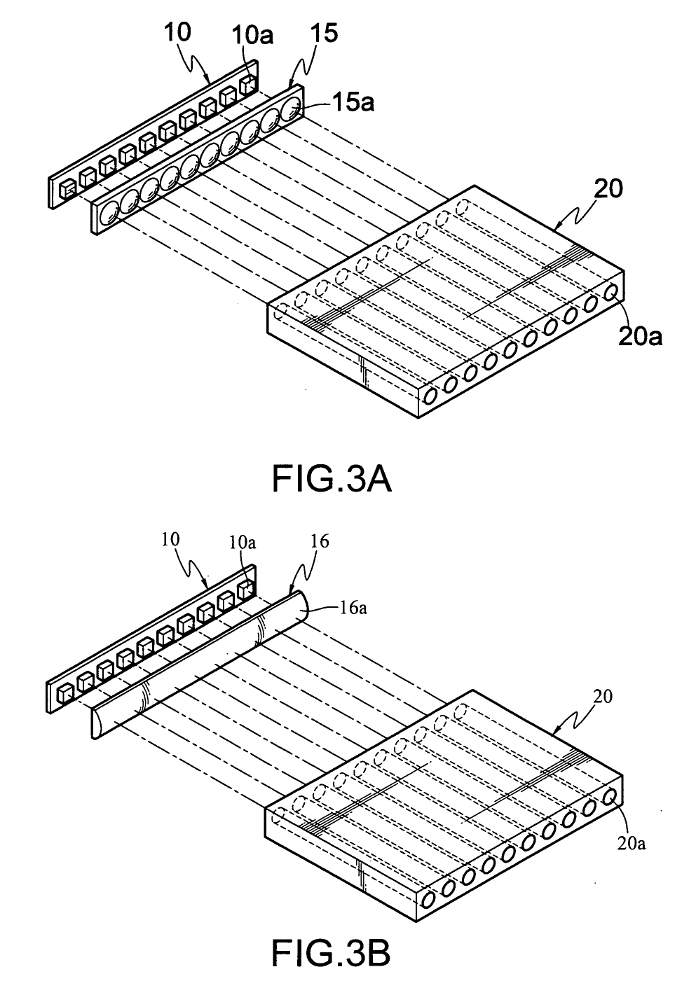

The structure of the optical print head 42 is described hereinafter. Referring to FIG. 3A, a schematic diagram of the perspective view of the optical print head according to the first embodiment of the invention is shown. The optical print head 42 includes an LED lighting plate 10, a matrix-type convergent micro-lens set 15, and a self-focusing micro-lens array 20. All of these devices are described in detail as follows.

The LED lighting plate 10 has a plurality of light-emitting diodes 10a arranged in a matrix. The LED lighting plate 10 receives the driving current to generate the emitting light having a wavelength of roughly around 740 nm.

The convergent micro-lens set 15 is disposed in the optical path of the emitting light between the LED lighting plate 10 and the self-focusing micro-lens array 20. One side of the convergent micro-lens set 15 has a planar surface facing the LED lighting plate 10 and another side has a plurality of convergent micro-lenses 15a facing the self-focusing micro-lens array 20. The convergent micro-lens 15a is a hemispherical curvature structure, which is used to allow the emitting light generated by the light-emitting diode 10a to be incident from its planar surface and exit from the hemispherical curvature structure of the convergent micro-lenses 15a. Thus, the scattering angle of the emitting light is converged and the emitting light is exposed within the designated area after passing through the convergent micro-lens set 15. The convergent micro-lens set 15 is made of light transmitting material such as glass, acrylic or the like.

The self-focusing micro-lens array 20 is used to receive the light from the convergent micro-lens set 15 and allow the emitting light to diffract in the lens, so as to expose the emitting light uniformly onto the predetermined imaging point. The self-focusing micro-lens array 20 can be classified into two types of a single row type and double row type, and is made of light transmitting material such as glass, acrylic or the like. In addition, the disposition of the convergent micro-lens set 15 does not affect the positions of the LED lighting plate 10 and the self-focusing micro-lens array 20.

In FIG. 3B, a schematic diagram of the perspective view of the optical print head according to the second embodiment of the invention is shown. The optical print head includes an LED lighting plate 10, a column-shaped convergent micro-lens set 16, and a self-focusing micro-lens array 20. All of these devices are described in detail as follows.

The LED lighting plate 10 has a plurality of light-emitting diodes 10a arranged in a matrix. The LED lighting plate 10 receives the driving current to generate the emitting light having a wavelength of roughly around 740 nm.

The column-shaped convergent micro-lens set 16 is disposed in the optical path of the emitting light between the LED lighting plate 10 and the self-focusing micro-lens array 20. One side of the column-shaped convergent micro-lens set 16 has a planar surface facing the LED lighting plate 10, and another side has a column-shaped curvature facing the self-focusing micro-lens array 20, which is used to allow the light generated by the light-emitting diode 10a to be incident from its planar surface and exit from the column-shaped curvature 16a. Thus, the scattering angle of the emitting light is converged and the emitting light is exposed within the designated area after passing through the column-shaped convergent micro-lens set 16. The column-shaped convergent micro-lens set 16 is made of light transmitting material such as glass, acrylic or the like.

The self-focusing micro-lens array 20 is used to receive the emitting light output from the column-shaped convergent micro-lens set 16 and allow the emitting light to diffract in the lens, so as to expose the emitting light uniformly onto the predetermined imaging point. The self-focusing micro-lens array 20 can be classified into two types of a single row type and double row type, and is made of light transmitting material such as glass, acrylic or the like. Besides, the disposition of the column-shaped convergent micro-lens set 16 does not affect the positions of the LED lighting plate 10 and the self-focusing micro-lens array 20.

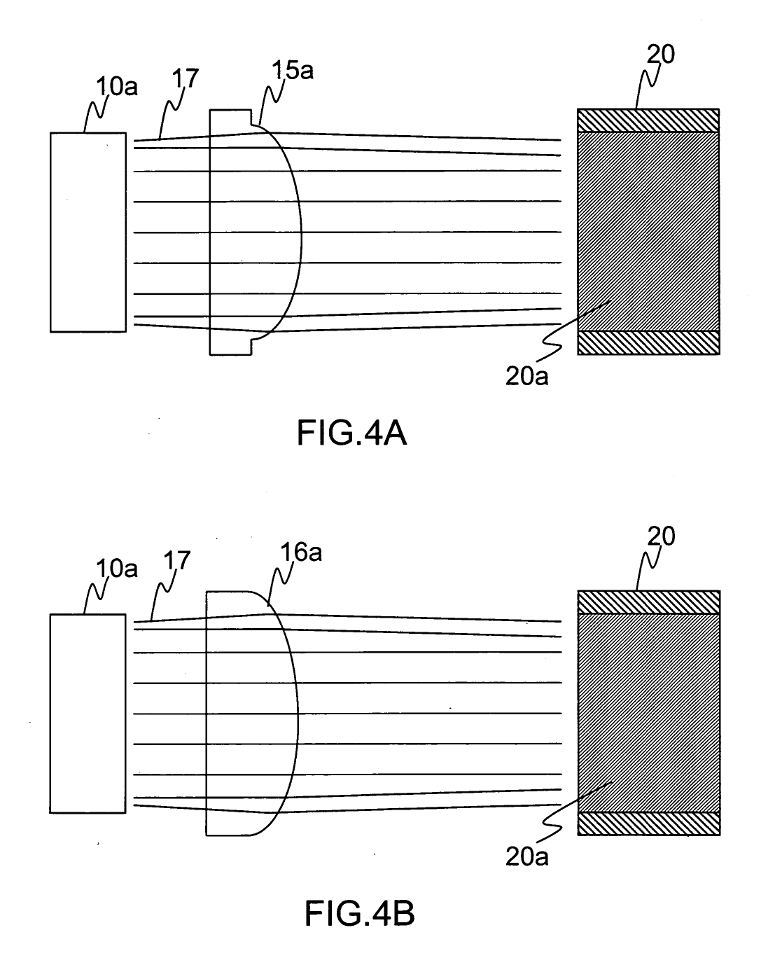

In FIG. 4A, a schematic diagram of the light movement of the optical print head according to the first embodiment of the invention is shown. Within the optical print head 42, the matrix-type convergent micro-lens 15a is disposed in the optical path of the emitting light between the light-emitting diode 10a and the self-focusing micro-lens array 20, and is close to the light-emitting diode 10a to avoid the emitting light scatter.

In the above-mentioned structure, when the emitting light 17 generated by the light-emitting diode 10a passes through the matrix-type convergent micro-lens 15a, the emitting light 17 is converged due to the curvature of the convergent micro-lens 15a, so that the light quantity of entering into the self-focusing micro-lens array 20 is increased. In addition, in FIG. 4B, a schematic diagram of the light movement of the optical print head according to the second embodiment of the invention is shown. The principle of emitting light path deviation and convergence is the same as that shown in FIG. 4A except that the matrix-type convergent micro-lens 15a is changed to the column-shaped convergent micro-lens 16a, so it is not repeated here.

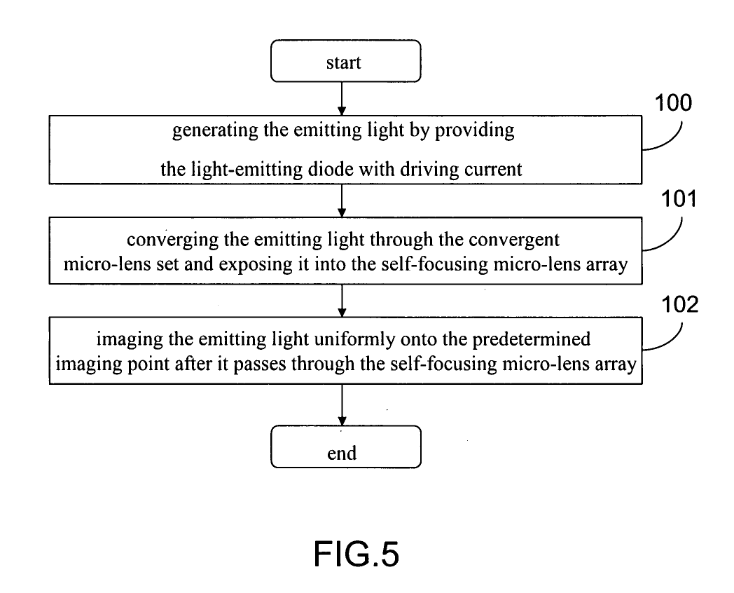

Referring to FIG. 5, a flowchart of the steps of the method of utilizing the optical print head according to the invention is shown. The convergent micro-lens set 15 is disposed in the optical path of the emitting light between the LED lighting plate 10 and the self-focusing micro-lens array 20, and is close to the LED lighting plate 10. The self-focusing micro-lens array 20 is made of light transmitting material such as glass, acrylic or the like.

The various steps of the method of utilizing the optical print head are described hereinafter. Firstly, drive the light-emitting diode by driving current to generate the emitting light (step 100). Next, converge the emitting light within the designated area through the convergent micro-lens set (step 101), so as to increase the light quantity of entering into the self-focusing micro-lens array. Then, the emitting light is uniformly exposed and imaged onto the predetermined imaging point (e.g. imaging on the photosensitive drum) after it passes through the self-focusing micro-lens array (step 102).

Finally, a table of the simulation test data according to the invention is shown below. In the invention, the design of the optical object is realized through Zemax software, and the test simulation is performed by TracePro software. In this simulation configuration of the invention, the diameter of the lens of the matrix-type convergent micro-lens set is 0.02 mm and its thickness is 0.01 mm. Besides, it is made of glass (BK7) or acrylic (PMMA). The diameter of the lens of the self-focusing micro-lens array is 0.6 mm and its thickness is 11.6666 mm. From the simulation data contained in the table, it is evident that the optical coupling efficiency of the optical print head can be raised from 0.655% to 1.927% , that is, an increase of about 2.944-fold, by applying the same light energy and with the convergent micro-lens set made of glass (BK7). Or, if the convergent micro-lens set made of acrylic (PMMA) is used, the optical coupling efficiency can be raised to 1.840% , which is an increase of about 2.811-fold.

| | | | | Optical | |
|---|---|---|---|---|---|
| | Self-focusing | Convergent | | coupling | |
| No. | micro-lens array | micro-lens set | Material | efficiency (%) | Raised-fold |
| 1 | Single row type | No | — | 0.655 | — |
| 2 | Single row type | Yes | Glass (BK7) | 1.972 | 2.944-fold |
| 3 | Single row type | Yes | Acrylic | 1.840 | 2.811-fold |
| | | | (PMMA) | | |
| 4 | Double row type | No | — | 1.104 | — |
| 5 | Double row type | Yes | Glass (BK7) | 3.102 | 2.810-fold |
| 6 | Double row type | Yes | Acrylic | 2.967 | 2.688-fold |
| | | | (PMMA) | | |

Furthermore, by comparing the second simulation data with the fourth simulation data, it is found that the optical coupling efficiency of the optical print head having the convergent micro-lens set and the single row self-focusing micro-lens array is higher than that of the optical print head having the double row self-focusing micro-lens array and without the convergent micro-lens set. The increase of optical coupling efficiency results in the increase of the quantity of light received at the receiving end (e.g. the photosensitive drum). Comparative speaking, there is no need to increase the driving current supplied to the LED lighting plate for generating the emitting light having higher energy. In other words, the driving current supplied to the LED lighting plate can be reduced, thus the problem of overheating while operating the light-emitting diode can be solved.

Through the utilization of the optical print head of the invention, the emitting light generated by the LED lighting plate is converged after passing through the convergent micro-lens set, and then is exposed into the self-focusing micro-lens array, so as to increase the light quantity of entering into the self-focusing micro-lens array, and the optical coupling efficiency of the optical print head is raised. Meanwhile, the driving current supplied to the LED lighting plate is decreased to reduce the operation temperature of the optical print head.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An optical print head, comprising:
a light-emitting diode (LED) lighting plate including a plurality of light-emitting diodes for generating an emitting light; and
a convergent micro-lens set and a self-focusing micro-lens array, wherein the convergent micro-lens set is disposed in the optical path of the emitting light between the LED lighting plate and the self-focusing micro-lens array to converge the emitting light generated from the LED lighting plate, the self-focusing micro-lens array is used to receive the emitting light transmitted from the convergent micro-lens set, and image the emitting light uniformly on a predetermined imaging point.

2. The optical print head as claimed in claim 1, wherein the convergent micro-lens set is a matrix-type convergent micro-lens set.

3. The optical print head as claimed in claim 2, wherein the matrix-type convergent micro-lens set is provided with a plurality of convergent micro-lenses corresponding to the arrangement of the light-emitting diodes.

4. The optical print head as claimed in claim 3, wherein one side of the lens of the matrix-type convergent micro-lens set is provided with a planar surface facing the LED lighting plate, and the other side is provided with a hemispherical curvature facing the self-focusing micro-lens array.

5. The optical print head as claimed in claim 1, wherein the convergent micro-lens set is a column-shaped convergent micro-lens set.

6. The optical print head as claimed in claim 5, wherein one side of the lens of the column-shaped convergent micro-lens set is provided with a planar surface facing the LED lighting plate, and the other side is provided with a column-shaped curvature facing the self-focusing-micro lens array.

7. The optical print head as claimed in claim 1, wherein the convergent micro-lens set is made of the glass material.

8. The optical print head as claimed in claim 1, wherein the convergent micro-lens set is made of the acrylic material.

9. The optical print head as claimed in claim 1, wherein the self-focusing micro-lens array is provided with a plurality of self-focusing micro-lenses corresponding to the arrangement of the light-emitting-diodes.

10. The optical print head as claimed in claim 1, wherein the self-focusing micro-lens array is of the single row type.

11. The optical print head as claimed in claim 1, wherein the self-focusing micro-lens array is of the double row type.

12. A method of utilizing the optical print head, wherein a convergent micro-lens set is disposed between a LED lighting plate and a self-focusing micro-lens array, the method comprising the following steps:
generating an emitting light by driving the LED lighting plate with a driving current;
converging the emitting light through the convergent micro-lens set and exposing it into the self-focusing micro-lens array; and
imaging the emitting light uniformly onto a predetermined imaging point after it passing through the self-focusing micro-lens array.

13. The method as claimed in claim 12, wherein the convergent micro-lens set is a matrix -type convergent micro-lens set.

14. The method as claimed in claim 13, wherein the matrix-type convergent micro-lens set is provided with a plurality of convergent micro-lenses corresponding to the arrangement of the light-emitting diodes.

15. The method as claimed in claim 14, wherein one side of the lens of the matrix-type convergent micro-lens set is provided with a planar surface facing the LED lighting plate, and the other side is provided with a hemispherical curvature facing the self-focusing micro-lens array.

16. The method as claimed in claim 12, wherein the convergent micro-lens set is a column-shaped convergent micro-lens set.

17. The method as claimed in claim 16, wherein one side of the lens of the column-shaped convergent micro-lens set is provided with a planar surface facing the LED lighting plate, and the other side is provided with a column-shaped curvature facing the self-focusing micro-lens array.

18. The method as claimed in claim 12, wherein the convergent micro-lens set is made of the glass material.

19. The method as claimed in claim 12, wherein the convergent micro-lens set is made of the acrylic material.

20. The method as claimed in claim 12, wherein the self-focusing-micro-lens array is of the single row type.

21. The method as claimed in claim 12, wherein the self-focusing-micro-lens array is of the double row type.
